(19) United States
(12) Patent Application Publication
(10) Pub. No.: US 2003/0042262 A1
(43) Pub. Date: Mar. 6, 2003

(54) Nestable multiple compartment tray for faux painting material and applicators

(76) Inventor: Todd Young, Springfield, MO (US)

Correspondence Address: MORGAN LEWIS & BOCKIUS LLP, 1111 PENNSYLVANIA AVENUE NW, WASHINGTON, DC, 20004, US

(21) Appl. No.: 09/946,114

(22) Filed: Sep. 4, 2001

(51) Int. Cl. B05C 21/00

(52) U.S. Cl. 220/570

(57) ABSTRACT

A nestable multiple compartment tray (10) for faux painting material and applicators is provided. The tray (10) comprises a rigid one-piece monolithic housing which comprises a bottom wall structure (11) presenting an outer perimeter defined by a plurality of spaced bottom wall segments (12) and a sidewall (14). The tray (10) is further comprised of a series of first divider walls (22 and 24) and at least one second divider wall (26). The sidewall (14) has a plurality of sidewall segments (15) which present front (16), rear (18), and opposing side (20) sections. The divider walls (22, 24, 26) cooperate with the sidewall segments (15) and bottom wall segments (12) to present individual fore (28) and aft (30) compartments. The fore compartments (28) are suited for receiving faux painting applicators and the aft compartments (30) are suited for receiving paint. Each divider wall (22, 24, 26) is constructed with at least partially spaced wall portions (32) which present corresponding cavities (34) therebetween. These wall portions (32) and cavities (34) are configured and oriented to permit interleaving of the divider walls (22, 24, 26) of a plurality of trays in nested stacked relationship.

### BACKGROUND OF THE INVENTION

1. Field of the Invention

The present invention is broadly concerned with a multiple compartment tray used for faux painting. More particularly, the invention pertains to such a tray capable of receiving and keeping separate from each other different faux painting materials and applicators. The tray is also formed in such a way that a plurality of trays may be stored in nested, stacked relationship.

2. Description of the Prior Art

Faux painting is a decorative type of painting often used as a substitute for traditional wallpaper or plain finishes. In faux painting, the artisan utilizes a variety of paint applicators, such as brushes and sponges, in order to achieve the desired finish. Common types of faux painting are marbleizing, stripping and sponging. For example, in marbleizing the artisan may apply paint to a wooden column in such a manner so as to give the appearance that the column is made of real marble.

Faux painting can often be a very tedious undertaking because of the level of detail involved in creating the various finishes. The artisan generally must use several different colors of paint and applicators in order to achieve a desired finish. The artisan needs to have close and convenient access to these different paints and applicators in order to be as efficient as possible in the faux painting process. There is a real need in the art for a painting tray capable of giving the artisan this close and convenient access to different paints and applicators, while at the same time capable of being carried using only one hand so that the artisan's other hand is free to apply the faux painting materials. It is also desirable, in a practical sense, for the tray to be nestably stackable with other such trays so as to minimize the storage space required when the trays are not in use.

### SUMMARY OF THE INVENTION

The current invention solves this problem by providing a nestable multiple compartment tray for faux paints and applicators. The invention comprises a rigid one-piece monolithic housing which comprises a bottom wall structure and a sidewall, a series of first divider walls and at least one second divider wall. The housing bottom wall structure presents an outer perimeter defined by a plurality of spaced bottom wall segments. The sidewall has a plurality of individual, spaced segments connected to respective bottom wall segments at the perimeter of the bottom wall structure. These sidewall segments present front, rear, and opposed side sections. The first divider walls extend between the front and rear sections of the sidewall, and the second divider wall intersects the first divider walls and extends between the opposing side sections of the sidewall.

The first and second divider walls cooperate with the sidewall segments and bottom wall segments to present individual fore applicator receiving compartments and aft paint receiving compartments. Preferably, the second divider wall is located closer to the front section of the sidewall than the rear section of the sidewall. This feature leaves the fore applicator receiving compartments narrower than the aft paint receiving compartments.

Each divider wall is constructed with at least partially spaced wall portions which present corresponding cavities therebetween. These wall portions and cavities are configured and oriented to permit interleaving of the divider walls of a plurality of trays in nested, stacked relationship.

In one embodiment, the second divider wall contains grooves for receiving either the paint applicators themselves or the handles of the paint applicators.

### BRIEF DESCRIPTION OF THE DRAWINGS

FIG. 1 is a view demonstrating a faux painting artisan using the nestable multiple compartment tray in a preferred manner.

FIG. 2 is a top view of the tray.

FIG. 3 is a side view of a plurality of trays in nested, stacked relationship with portions of the tray sidewall cut away.

FIG. 4 is an elevational view of the tray demonstrating the paint and paint applicator-receiving compartments.

FIG. 5 is an elevational view of the tray demonstrating the bottom wall segments and cavities formed by the partially spaced divider wall segments.

FIG. 6 is an elevational view of the tray with wall segments of the fore applicator receiving compartments cut away demonstrating the applicator receiving grooves of the bight section of the cross-divider walls.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

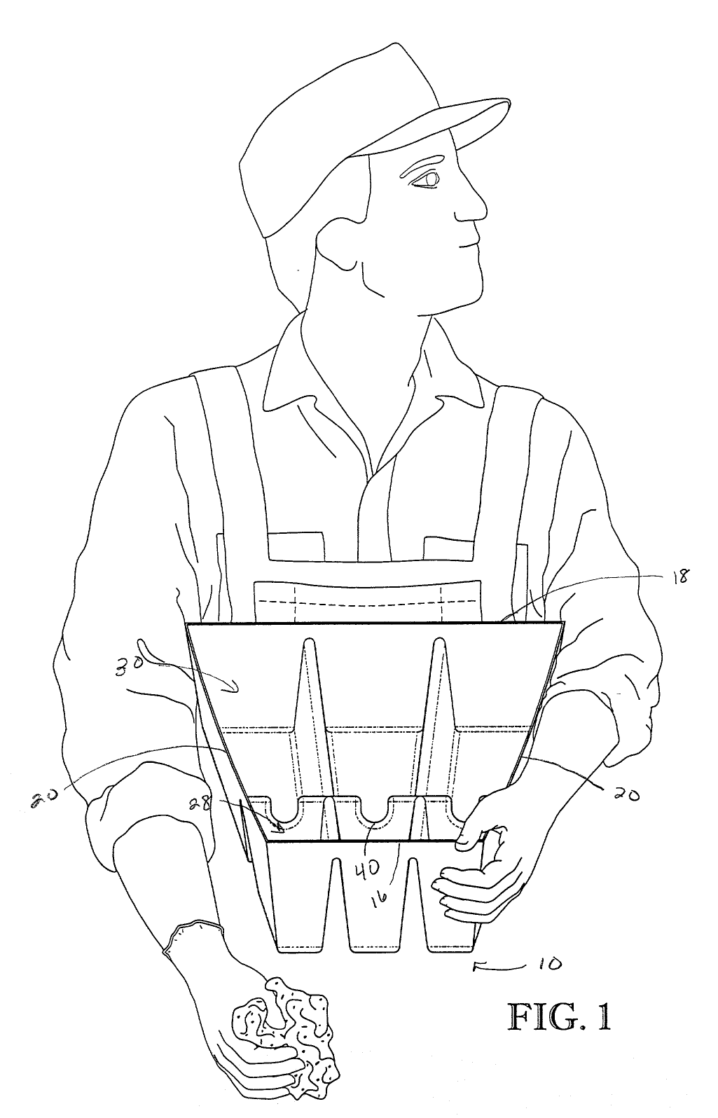

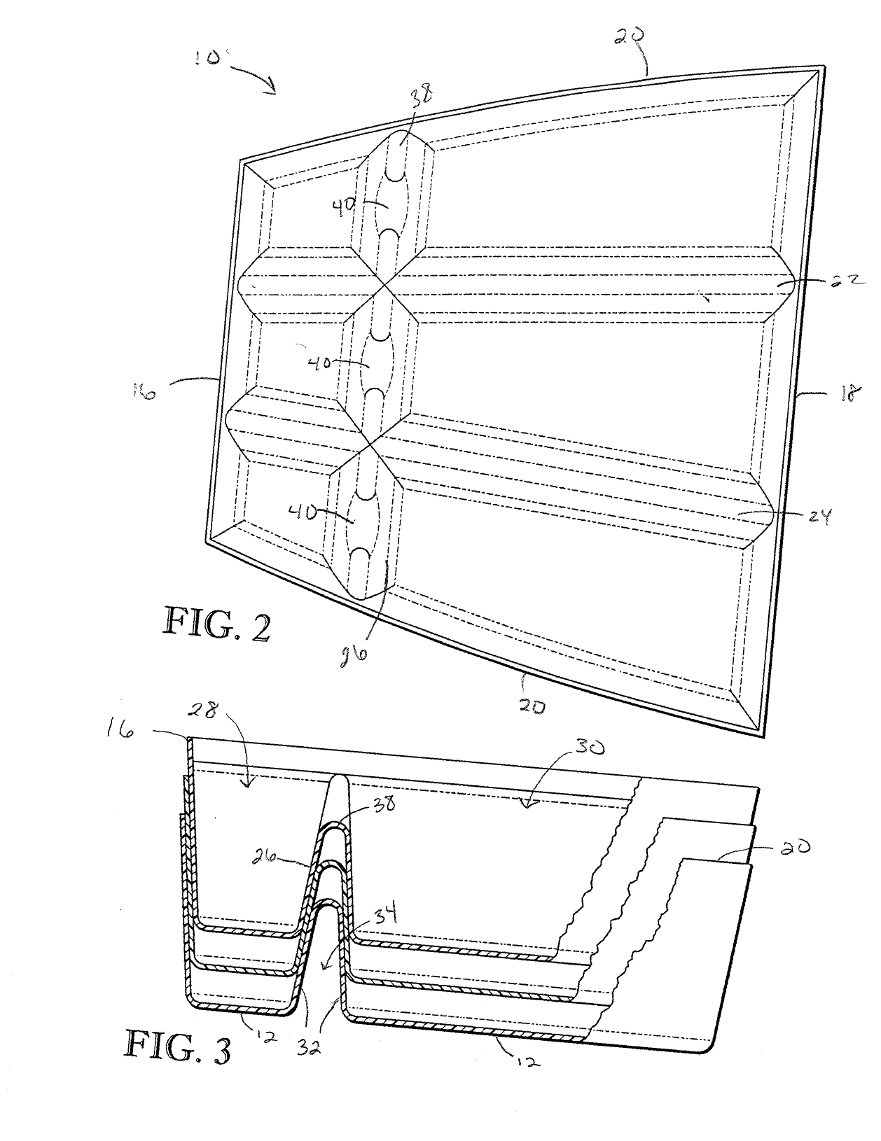

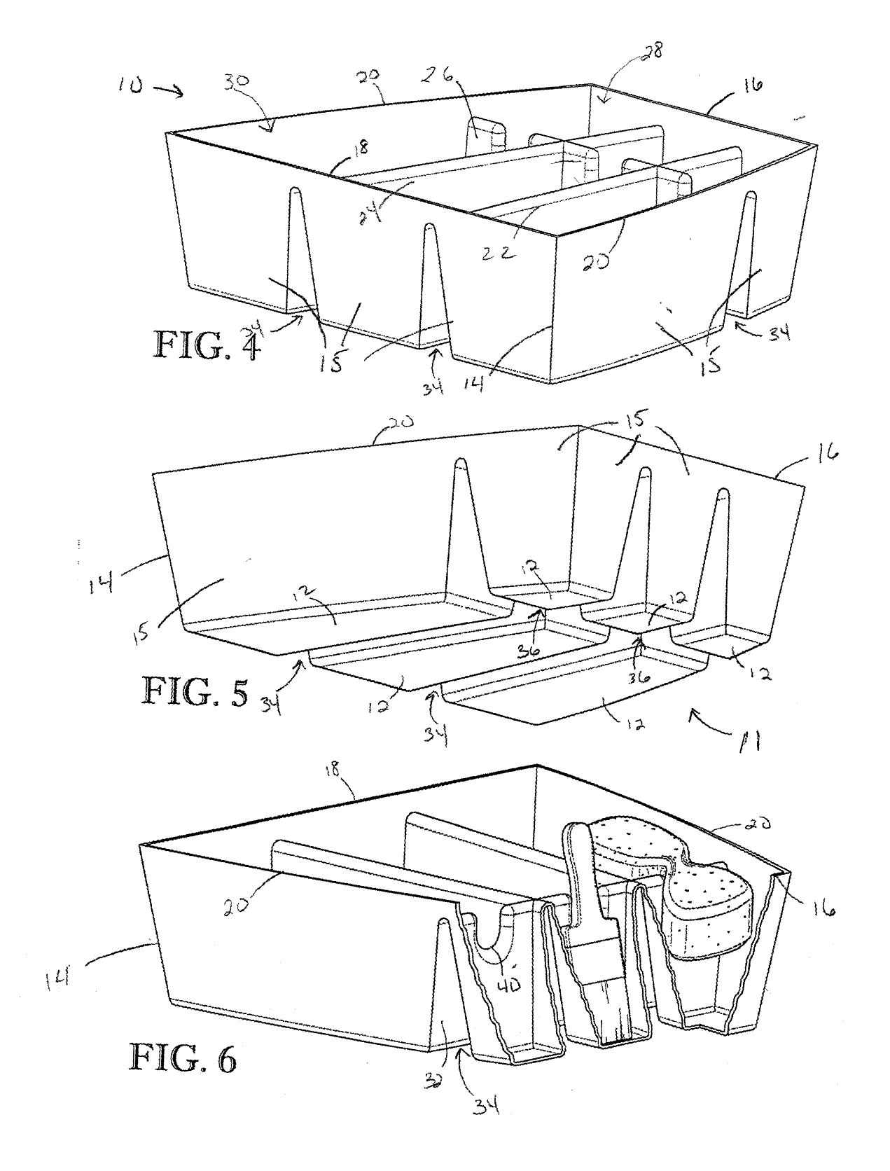

Turning now to the drawings, and more specifically FIG. 1, the nestable multiple compartment tray 10 is of one-piece monolithic construction. The tray may be constructed from any rigid material suitable for holding faux painting materials, however, preferably, the tray is constructed of a rigid, molded plastic material. As shown in FIG. 5, the tray 10 is comprised of a housing comprising a bottom wall structure 11 presenting an outer perimeter and defined by a plurality of spaced bottom wall segments 12. The housing also comprises a sidewall 14 having a plurality of individual, spaced segments 15 connected to respective bottom wall segments 12 at the perimeter of the bottom wall structure. The sidewall segments 15 present front 16, rear 18 and opposing side 20 sections. As shown in FIG. 2, the tray further comprises a series of first divider walls 22 and 24 and at least one second divider wall 26. The first divider walls 22, 24 cooperate with the sidewall segments 16, 18, 20 to present individual fore compartments 28 and aft compartments 30. Preferably the first divider walls 22, 24 extend the full length between the front 16 and rear 18 sections of the sidewall 14, and preferably the second divider wall 26 extends the full length between the opposing side sections 20. In the preferred embodiment shown in FIG. 4, the divider walls 22, 24, 26 also have a height approaching the height of the sidewall 14.

FIG. 1 demonstrates one manner of use of the tray 10 by a faux painting artisan. The artisan holds the tray 10 so that the rear section 18 of the sidewall is against the artisan's chest. The artisan, using one arm wrapped around one of the opposed side sections 20 of the tray 10, supports the front section of the sidewall 16 using his hand. Holding the tray in this fashion leaves the artisan's other arm and hand free to hold an applicator and apply the faux painting materials.

In the preferred embodiment of the invention, the second divider wall 26 is located closer to the front section of the sidewall 16 than the rear section of the sidewall 18. This leaves the fore compartments 28 narrower than the aft compartments 30. The fore compartments 28 are suitable for receiving paint applicators as shown in FIG. 6, and the aft compartments 30 are suitable for receiving the paint materials used in the faux painting process.

Another feature of the preferred embodiment of this invention is that the tray is designed in such a way to allow a plurality of trays to be nested together, thus facilitating compact storage of the trays. As FIG. 3 demonstrates using the second divider wall 26 as an example, each of the divider walls 22, 24, 26 has at least partially spaced wall portions 32 presenting corresponding cavities 34 therebetween. These cavities 34 are configured and oriented to permit interleaving of the divider walls 22, 24, 26 of a plurality of trays in nested, stacked relationship. The intersections of the first divider walls 22, 24 with the second divider wall 26 define cavity sections 36 at least partly bounded by the partially spaced wall portions 32 of the intersecting divider walls.

The divider walls 22, 24, 26 present bight sections 38 that connect the spaced wall portions 32. In the preferred embodiment of this invention, the spaced wall portions 32 and the bight section 38 form an inverted U-shape thus defining an inverted U-shaped cavity 34. The bight sections 38 of the cross-divider walls 26 may also contain grooves 40 for receiving paint applicators. As shown in FIG. 6, these grooves 40 may be arcuate-shaped depressions formed in the bight sections 38 of the second divider wall 26.

It is also preferable that the divider walls 22, 24, 26 present a height approaching the height of the sidewall 14. It is most preferable that the sidewall 14 extend above the height of the divider walls 22, 24, 26. This added sidewall height provides additional structural support thereby increasing the rigidity of the tray 10.

It is also preferred that the opposed side sections of the sidewall 20 converge between the front 16 and rear 18 sections of the sidewall so that the space between the opposed side sections 20 proximal the front section of the sidewall 16 is less than the space between the opposed side sections 20 proximal the rear section of the sidewall 18. In preferred embodiments, this convergence of the side sections of the sidewall 20 is such that the sidewall takes on a generally trapezoidal shape.

In the most preferred embodiment of the invention, the length of front section of the sidewall 16 is about 8 inches. The length of the rear section of the sidewall 18 is about 16 inches and the lengths of the opposing side sections of the sidewall 20 are about 13 inches. In this embodiment, the sidewall 14 presents a height of about 5.5 inches.

I claim:

1. A nestable multiple compartment tray for faux paints and paint applicators comprising:
a rigid one-piece monolithic housing comprising a bottom wall structure presenting an outer perimeter and defined by a plurality of spaced bottom wall segments, and a sidewall having a plurality of individual, spaced segments connected to respective bottom wall segments at the perimeter of the bottom wall structure,
said sidewall segments presenting front, rear and opposed side sections;
a series of first divider walls extending between the front and rear sections of the sidewall, and at least one second divider wall intersecting said first divider walls and extending between opposed side sections of the sidewall, the first and second divider walls cooperating with the sidewall segments and bottom wall segments to present individual fore applicator receiving compartments and aft paint receiving compartments,
said second divider wall being located closer to the front section of the sidewall than the rear section of the sidewall thereby leaving said fore applicator receiving compartments narrower than said aft paint receiving compartments,
each of said divider walls having at least partially spaced wall portions presenting corresponding cavities therebetween, said wall portions and the cavities presented thereby being configured and oriented to permit interleaving of the divider walls of a plurality of trays in nested, stacked relationship.

2. The nestable multiple compartment tray of claim 1, said opposed side sections of the sidewall converging between the front and rear sections of the sidewall so that the space between the opposed side sections proximal the front section of the sidewall is less than the space between the opposed side sections proximal the rear section of the sidewall.

3. The nestable multiple compartment tray of claim 1, said second divider wall presenting a bight section having grooves formed therein for receiving said paint applicators.

4. The nestable multiple compartment tray of claim 3, said grooves being arcuate-shaped recesses.

5. The nestable multiple compartment tray of claim 1, said partially spaced divider wall portions presenting inverted U-shaped cavities.

6. The nestable multiple compartment tray of claim 1, said first divider walls extending the full length between the front and rear sections of the sidewall.

7. The nestable multiple compartment tray of claim 1, said second divider wall extending the full length between the opposing side sections of the sidewall.

8. The nestable multiple compartment tray of claim 1, the intersections of said first and second divider walls defining cavity sections at least partly bounded by the partially spaced wall portions of the intersecting divider walls.

9. The nestable multiple compartment tray of claim 1, said divider walls having a height approaching the height of said sidewall.

10. A compartmentalized tray comprising:
a housing presenting a bottom wall structure and an upstanding sidewall having opposed front and rear wall sections, and opposed side sections extending between the front and rear wall sections;
a plurality of spaced apart fore and aft extending first divider walls extending between said front and rear wall sections, and at least one second divider wall extending between said side sections and intersecting said first divider walls,
said bottom wall structure, sidewall, and said first and second divider walls defining a series of fore and aft compartments within the housing, and
said second divider wall having at least one groove formed therein and communicating with one of said compartments.

11. The tray of claim 10, said second divider wall positioned closer to said front wall section than said rear wall section.

12. The tray of claim 10, said side sections converging between the front and rear wall sections so that the space between the side sections proximal the front wall section is less than the space between the side sections proximal the rear wall section.

13. The tray of claim 10, said first and second divider walls having a height approaching the height of said sidewall.

14. The tray of claim 10, said second divider wall having one groove formed therein for each of said fore compartments.

15. The tray of claim 10, said bottom wall structure comprising a plurality of spaced bottom wall segments.

16. The tray of claim 10, each of said first and second divider walls having at least partially spaced wall portions presenting cavities therebetween.

17. The tray of claim 16, said partially spaced wall portions and said cavities being configured and oriented to permit interleaving of the divider walls of a plurality of trays in nested, stacked relationship.

18. The tray of claim 16, said partially spaced wall portions presenting inverted U-shaped cavities.

19. A compartmentalized tray comprising:
a housing presenting a bottom wall structure and an upstanding sidewall having opposed front and rear wall sections, and opposed side sections extending between the front and rear wall sections;
a plurality of spaced apart fore and aft extending first divider walls extending between said front and rear wall sections, and at least one second divider wall extending between said side sections and intersecting said first divider walls,
said second divider wall positioned closer to said front wall section than said rear wall section, and
said bottom wall structure, sidewall, and said first and second divider walls defining a series of compartments within the housing.

20. The tray of claim 19, said second divider wall having at least one groove formed therein and communicating with one of said compartments.

21. The tray of claim 20, said second divider wall having one groove formed therein for each of said fore compartments.

22. The tray of claim 19, said first and second divider walls having a height approaching the height of said sidewall.

23. The tray of claim 19, said bottom wall structure comprising a plurality of spaced bottom wall segments.

24. The tray of claim 19, said side sections converging between the front and rear wall sections so that the space between the side sections proximal the front wall section is less than the space between the side sections proximal the rear wall section.

25. The tray of claim 19, each of said first and second divider walls having at least partially spaced wall portions presenting cavities therebetween.

26. The tray of claim 25, said partially spaced wall portions and said cavities being configured and oriented to permit interleaving of the divider walls of a plurality of trays in nested, stacked relationship.

27. The tray of claim 25, said partially spaced wall portions presenting inverted U-shaped cavities.

28. A compartmentalized tray comprising:
a housing presenting a bottom wall structure and an upstanding sidewall having opposed front and rear wall sections, and opposed side sections extending between the front and rear wall sections,
said side sections converging between the front and rear wall sections so that the space between the side sections proximal the front wall section is less than the space between the side sections proximal the rear wall section;
a plurality of spaced apart fore and aft extending first divider walls extending between said front and rear wall sections, and at least one second divider wall extending between said side sections and intersecting said first divider walls, and
said bottom wall structure, sidewall, and said first and second divider walls defining a series of compartments within the housing.

29. The tray of claim 28, said second divider wall having at least one groove formed therein and communicating with one of said compartments.

30. The tray of claim 28, said second divider having one groove formed therein for each of said fore compartments.

31. The tray of claim 28, said second divider wall positioned closer to said front wall section than said rear wall section.

32. The tray of claim 28, said first and second divider walls having a height approaching the height of said sidewall.

33. The tray of claim 28, said bottom wall structure comprising a plurality of spaced bottom wall segments.

34. The tray of claim 28, each of said first and second divider walls having at least partially spaced wall portions presenting cavities therebetween.

35. The tray of claim 34, said partially spaced wall portions and said cavities being configured and oriented to permit interleaving of the divider walls of a plurality of trays in nested, stacked relationship.

36. The tray of claim 34, said partially spaced wall portions presenting inverted U-shaped cavities.
